(19) United States
(12) Patent Application Publication
(10) Pub. No.: US 2005/0278265 A1
(43) Pub. Date: Dec. 15, 2005

(54) Method for providing postal deliveries with franking stamps

(76) Inventors: Jurgen Lang, Gladbach (DE); Bernd Meyer, Konigswinter (DE)

Correspondence Address: CONNOLLY BOVE LODGE & HUTZ, LLP, P O BOX 2207, WILMINGTON, DE, 19899, US

(21) Appl. No.: 10/416,052

(22) PCT Filed: Nov. 6, 2001
(86) PCT No.: PCT/DE01/04129

§ 371 Date: Sep. 3, 2003

(30) Foreign Application Priority Data
Nov. 7, 2000 (DE) 100 55 145.9

(51) Int. Cl. G06F 17/00

(52) U.S. Cl. 705/408

(57) ABSTRACT

The invention is drawn to a method for providing mailpieces with postage indicia, whereby a customer system controls the printing of postage indicia on mailpieces, characterized in that, an entry is made in a file indicating which postage indicia generated by a printing command were not associated with the sending of a mailpiece, and in that the customer system transmits identification data to the server pertaining to the mailpieces that are not to be sent, in that the server forwards the identification data to at least one checking station, and in that the checking station recognizes a mailpiece that has been mailed even though the postage indicium used by the customer system was marked as not sent.

The invention relates to a method for providing mailpieces with postage indicia, whereby a customer system controls the printing of postage indicia on mailpieces.

It is a known procedure to generate a postage indicium by reproducing digitized data in encrypted form. Since it is preferred to implement this method using personal computers, this method will be referred to hereinafter as PC franking for short. The designation PC franking, however, is not to be construed in any way as a limitation since the generation of digital data can be carried out on any type of computer and is not limited to personal computers. The term “computer” is not to be understood in any way as a limitation. This refers to any unit that is suitable for executing computations, for example, a work station, a personal computer, a microcomputer or a circuit that is suitable for executing computations. For example, it can also be a personal digital assistant (PDA).

An introduction of the franking procedure being planned by the Deutsche Post AG has been made available to the public through a presentation on the Internet.

The PC franking presented comprises several steps, in which a customer loads a postage amount, generates postage indicia from the postage amount and prints these out on a printer. The printout is in the form of a PC postage indicium containing a machine-readable, two-dimensional matrix code that can be employed to check the validity of the postage indicium.

The mailpiece provided with the PC postage indicium can be dropped off at the postal service provider. The postal service provider delivers the mailpiece after checking the validity of the postage indicium.

In order to prevent fraudulent generation of postage indicia, the available postage amount is reduced as soon as the applicable printing command is given.

This, however, entails the problem that the printing data could be lost after the printing command has been given, but before the actual printout of the postage indicium. This can happen, for instance, in case of a system crash, a power failure, a paper jam or a printout with an empty ink cartridge or empty toner cartridge.

The invention is based on the objective of refining a process of this type in such a way as to avoid charging the user for postage fees for postage indicia that were not used to send mailpieces.

According to the invention, this objective is achieved in that an entry is made in a file indicating which postage indicia generated by a printing command were not associated with the sending of a mailpiece.

An especially simple refunding of postage fees is possible in that the file is incorporated into a fee refund form.

Advantageously the method is carried out in such a way that the file and/or the fee refund form are transmitted to a refund station.

In order to increase the data security, it is advantageous for the transmission to be made to a server and for the customer system to transmit identification data to the server pertaining to the mailpieces that are not to be sent, and for the server to forward the identification data to at least one checking station.

The server is preferably a logical node of a communication network, but any other computer equipped with interfaces, or any other computation unit can also be used as the server.

Through the transmission of the identification data, fraudulent use of the automated refund feature is avoided. Checking stations—which are advantageously situated in mail centers, but which can also be consolidated outside of the mail centers, for example, at one or more central places—can recognize a mailpiece that has been mailed even though the postage indicium used by the customer system was marked as not sent.

Therefore, it is possible for the file or rather for the fee refund form to be stored unencrypted in the customer system. A fraudulent entry of data pertaining to postage indicia not used for sending mailpieces can be discovered by sorting out such mailpieces about which the mail centers received a message that they are considered as not having been sent.

Manual entry of mailing data can also be permitted by the system since a misuse of this manual entry option can be avoided.

For example, the user of the customer system can manually enter data on mailings that have not been sent. Such a manual entry can be either excluded or permitted, for example, through the introduction of an encryption. In the case where a manual data entry is permitted, the user of the customer system can, for example, remove a letter marked with a postage indicium before sending it if he/she has subsequently decided not to send the letter marked with the postage indicium.

A further increase of the data security is possible in that a fee refund only takes place if when documentation pertaining to the non-mailing or the non-printing is attached to the form for postage indicia that are to be refunded.

This documentation is generated, for example, automatically by the system, for instance, by scanning the postage indicia in question or by recording system data pertaining to the non-printing of the postage indicium.

Electronic storage of this data is especially advantageous because this allows automatic checking.

Preferably, the transmission takes place electronically, for example, by means of a message in a communication system, an e-mail or through entry into a website.

Further advantages, special features and advantageous embodiments of the invention ensue from the subordinate claims and from the presentation below of preferred embodiments with reference to the drawings.

The drawings show the following:

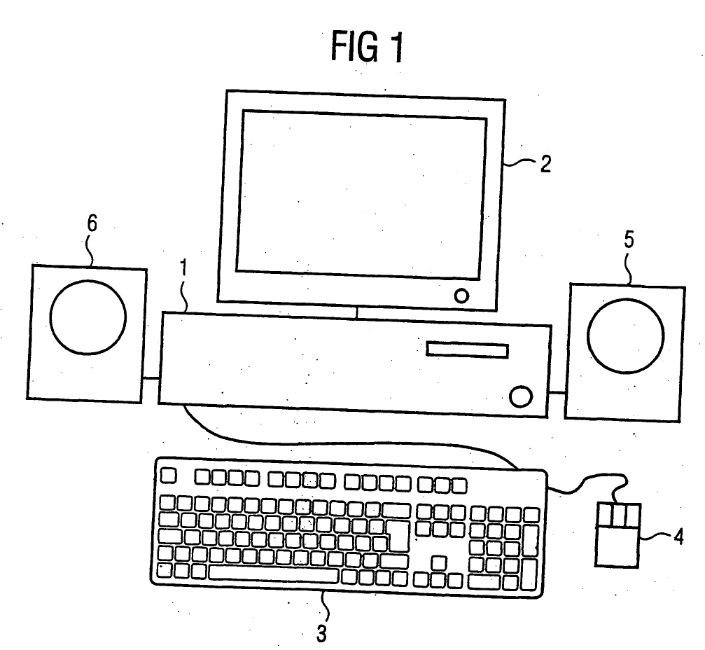

FIG. 1—a customer system for generating postage indicia;

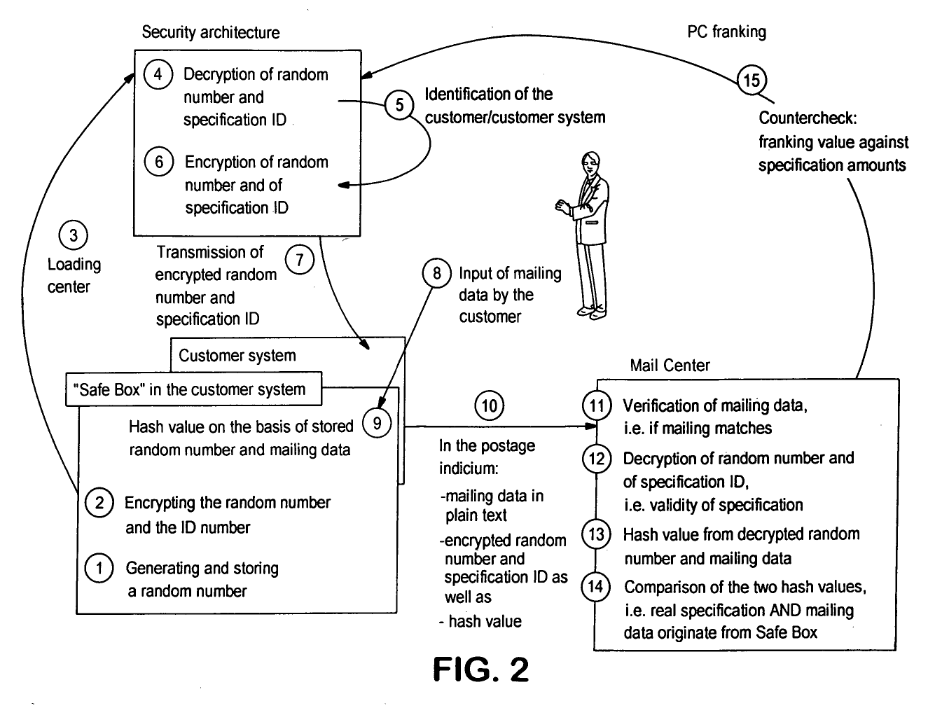

FIG. 2—a total system consisting of a customer system and an external server and

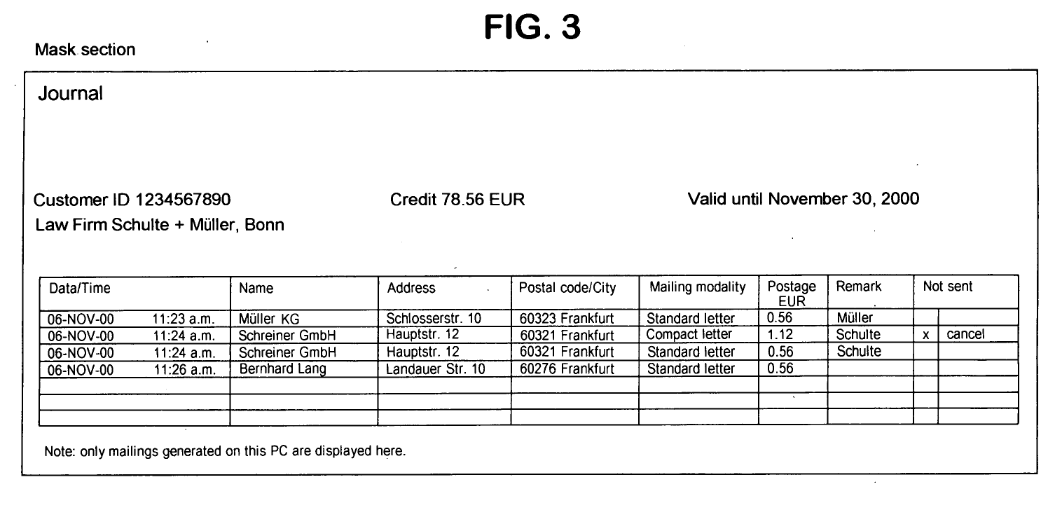

FIG. 3—a screen mask containing information about the mailpiece that was not sent.

The customer system shown in FIG. 1 comprises, for example, a personal computer 1 with a monitor 2, a keyboard 3, a mouse 4 and a connected printer 5.

The customer system is not dependent on the hardware shown, but rather can have a wide variety of material forms, for example, it can be stored in a single storage module, for instance, in a chip card.

In the total system shown in FIG. 2, the customer system is in contact with an external server. Advantageously, the external server consists of a loading center (value transfer center).

The server can be any computer. The designation server does not have any limiting meaning but rather refers to the additional possibility of systematically exchanging data via interfaces.

One of the interfaces is preferably provided by the customer system. This interface, which will be referred to hereinafter as the customer interface, allows an input of data via postage indicia that were electronically generated but that were not actually used for sending mail.

Preferably, the customer system contains a security module that allows forgery-proof generation of postage indicia

The customer system is preferably part of a total system that contains checking and security mechanisms in all of its components.

Another component of the total system is, for example, a value transfer center. The properties of the value transfer center, which prevent an unauthorized loading of payment amounts are not presented, since the customer system can be connected to any value transfer center that is secured in this manner.

Security Architecture

For the PC franking, a fundamental security architecture is provided that combines the advantages of various existing approaches and that offers a high level of security with simple means.

The security architecture preferably comprises essentially three units that are shown in a preferred arrangement in FIG. 2:

A value transfer center in which the identity of the customer and of his/her customer system are known.

A security module which, as hardware/software that cannot be manipulated by the customer, ensures the security in the customer system (e.g. dongle or chip card with off-line solutions or equivalent server with on-line solutions).

A mail center where the validity of the postage indicia is checked, or where manipulations to the value amount as well as to the postage indicium are recognized.

The individual process steps that are carried out in the value transfer center, customer system and mail center will be shown below in the form of a schematic diagram. The precise technical communication process, however, diverges from this schematic diagram (e.g. several communication steps to achieve a transfer shown here). In particular, in this depiction, the confidentiality and integrity of the communication between the identified and authenticated communication partners is a prerequisite.

Customer System

1. Within the security module, a random number that the customer does not come to know is generated and temporarily stored.

2. Within the security module, the random number is combined and encrypted together with an unambiguous identification number (security module ID) of the customer system, or of the security module, in such a way that only the value transfer center is capable of performing a decryption.

In an especially preferred embodiment, the random number, together with a session key previously issued by the value transfer center and with the utilization data of the communication (request for establishing an account amount), is encrypted with the public key of the value transfer center and is digitally signed with the private key of the security module. This prevents the request from having the same form each time an account amount is loaded and from being able to be used for the fraudulent loading of account amounts (replay attack).

3. The cryptographically handled information from the customer system is transmitted to the value transfer center within the scope of loading an account amount. Neither the customer nor third parties can decrypt this information.

In actual practice, use is made of asymmetrical encryption with the public key of the communication partner (value transfer center or security module).

Along with the possibility of a preceding exchange of keys, another option is a symmetrical encryption.

Value Transfer Center

4. In the value transfer center, among other things, the random number that can be assigned to the identification number of the security module (security module ID) is decrypted.

5. Through a request in the postage application database, the security module ID is assigned to a customer of the Deutsche Post.

6. In the value transfer center, a loading procedure identification number is formed that contains parts of the security module D, the actual account amount, etc. The decrypted random number is encrypted together with the loading procedure identification number in such a way that only the mail center is capable of performing a decryption. The customer, on the other hand, is not capable of decrypting this information. (The loading procedure identification number is additionally encrypted in a form that can be decrypted by the customer system). In actual practice, the encryption is carried out with a symmetrical key according to TDES which is exclusively present in the value transfer center as well as in the mail centers. Symmetrical encryption is used here because of the demand for fast decryption procedures during the processing.

7. The encrypted random number and the encrypted loading procedure identification number are transmitted to the customer system. Neither the customer nor third parties can decrypt this information. Through the sole administration of the postal service provider's own, preferably symmetrical, key in the value transfer center and in the mail centers, the key can be exchanged at any time and key lengths can be changed as needed. This is a simple way to ensure a high level of security against manipulation. In actual practice, the loading procedure identification number is additionally made available to the customer in a non-encrypted form.

Customer System

8. Within the scope of creating a postage indicium, the customer compiles the mailing-specific information or mailing data (e.g. value of postage, postal class, etc.) that are transmitted into the security module.

9. Within the security module, a hash value is formed, among other things, on the basis of the following information
excerpts from the mailing data (e.g. value of postage, postal class, date, postal code, etc.),
the temporarily stored random number (which was generated within the scope of the loading of an account amount)
and optionally the loading procedure identification number.

10. The following data, among other things, is integrated into the postage indicium:
excerpts from the mailing data in plain text (e.g. value of postage, postal class, date, postal code, etc.),
the encrypted random number and the encrypted loading procedure identification number from the value transfer center and
the hash value formed within the security module on the basis of the mailing data, of the random number and of the loading procedure identification number.
   Mail Center

11. In the mail center, firstly, the mailing data is checked. If the mailing data integrated into the postage indicium does not match the mailing, then this is either a fraudulent franking or else a fantasy marking or smear. The mailing has to be sent over to the payment assurance system.

12. In the mail center, the random number and the loading procedure identification number, which were transmitted to the customer system within the framework of with the account amount, are decrypted. For this purpose, only one single (symmetrical) key is needed in the mail center. If individual keys were used, however, a plurality of keys would have to be used.

13. In the mail center, a hash value is formed by means of the same process on the basis of the following information:
excerpts from the mailing data,
the decrypted random number,
the decrypted loading procedure identification number.

14. In the mail center, the self-generated and the transmitted hash value are compared. If they both match, then the transmitted hash value was formed with the same random number that was also transmitted to the value transfer center within the scope of loading the account amount. Consequently, this is a real, valid account amount as well as mailing data that was communicated to the security module (validity verification). As far as the effort is concerned, the decryption, the formation of a hash value and the comparison of two hash values is theoretically the same as that of a signature verification. However, due to the symmetrical decryption, there is a time advantage over the signature verification.

15. Anomalies between loaded account amounts and franking amounts can be ascertained retrospectively by means of a countercheck in the background system (verification in terms of mailing duplicates, balance formation in the background system).

The fundamental security architecture presented does not comprise the separately secured administration of the account amounts (purse function), the security of the communication between the customer system and the value transfer center, the mutual identification of the customer system and of the value transfer center, and the initialization for the secure start-up of a new customer system.

Attacks on the Security Architecture

The described security architecture is secure against attacks through the following:
Third parties cannot use the intercepted (copied) successful communication between a customer system and the value transfer center for fraudulent purposes (replay attacks).
Third parties or customers cannot simulate a legitimate customer system vis-á-vis the value transfer center by using a manipulated customer system. If a third party or a customer replicates the transmission of a random number and of a safe-box ID that were not generated within a security module but that he/she knows, then the loading of the account amounts will fail either because of the separately executed identification of the legitimate customer through user name and password, or else because of the knowledge of the private key of the security module, which the customer may never know under any circumstances. (This is why the initialization process for key generation in the security module and the certification of the public key have to be properly carried out by the customer system provider.)
Third parties or customers cannot load valid account amounts into a customer system using a simulated value transfer center. If a third party or a customer replicates the functionality of the value transfer center, then this replicated value transfer center will not succeed in generating an encrypted loading procedure identification number that can be properly decrypted in the mail center. Moreover, the certificate of the public key of the value transfer center cannot be forged.
Customers cannot circumvent the value transfer center in order to create a postage indicium whose loading procedure identification number is encrypted in such a way that it could be decrypted in the mail center as being valid.

In order to increase data security, especially during searching, an exhaustive number of random numbers have to be used for forming the hash value.
Therefore, the length of the random number should be as large as possible, preferably at least 12 bytes (96 bits).

The security architecture employed is superior to the prior art methods, thanks to the possibility of using customer-specific keys, without it being necessary to keep keys ready in places intended for decryption, especially in mail centers. This advantageous embodiment is fundamentally different from the known systems according to the Information-Based Indicia Program (IBIP).

Advantages of the Security Architecture

The following features characterize the described security architecture in comparison to the known IBIP model of the U.S. Postal Service in the United States:
The actual security is ensured in the systems of the Deutsche Post (value transfer center, mail center, payment assurance system) and is thus completely within the sphere of influence of the Deutsche Post.
No signatures are used in the postage indicium, but rather technically equivalent and equally secure (symmetrically) encrypted data and hash values are used. For this purpose, in the simplest case, only a symmetrical key is used that is exclusively within the sphere of influence of the Deutsche Post and that is thus easy to replace.
In the mail center, a verification of all of the postage indicia features is possible (instead of on the basis of spot checks).
The security concept is based on a simple inherently closed verification cycle that matches a background system harmonized with this.
The system recognizes even duplicates, which can otherwise hardly be detected.
Invalid fantasy markings can be recognized with great accuracy using this method.
In addition to the plausibility check, with all of the postage indicia, the loading procedure identification number can be checked in real time.
   Types of Mailing

With PC franking, all of the products of the mailing service provider such as, for example, “national letter” (including extra services) and “national direct marketing” can be franked by the mailing service provider according to a preceding stipulation.

By the same token, this method can be used for other shipping forms such as package and express shipments.

The maximum monetary amount that can be loaded via the value transfer center is set at an appropriate level. The amount can be selected depending on the requirement of the customer and on the security needs of the postal service provider. Whereas a monetary amount of several hundred German marks at the maximum is especially advantageous for use by private customers, large-scale customers require far higher monetary amounts. An amount in the range of about 500 German marks is suitable for high-volume private households as well as for free-lancers and small businesses. From a system-related technical standpoint, the value stored in the purse should preferably not exceed twice the value amount.

Incorrectly Franked Mailings

Letters, envelopes, etc. that have already been printed and that are incorrectly franked are credited back to the customer in the form of a valid postage indicium.

Through suitable measures, for example, by stamping mailpieces as they arrive at the mail center, it is possible to ascertain whether a mailpiece has already been delivered. This prevents customers from getting already delivered mailpieces back from the recipient and from submitting them to the postal service provider, for example, Deutsche Post AG in order to obtain a refund.

The return to a central place of the postal service provider, for example, Deutsche Post, allows a high degree of payment assurance through a comparison of the data with account amounts and this provides knowledge about the most frequent reasons for returns. This might offer the possibility of fine-tuning by changing the entry prerequisites with the objective of reducing the return rates.

Validity of Postage Indicia

For purposes of payment assurance, account amounts purchased by the customer are valid, for example, for only three months. An indication to this effect should be included in the agreement with the customer. If franking values cannot be used up within 3 months, then the customer system has to contact the value transfer center for a renewed creation of postage indicia. During this contact, like with the proper loading of account amounts, the remaining amount of an old account amount is added to a newly issued account amount and made available to the customer under a new loading procedure identification number.

Special Operational Handling

Fundamentally, the postage indicia can have any desired form in which the information contained therein can be reproduced. However, it is advantageous to configure the postage indicia in such a way that they have the form of bar codes, at least in certain areas. With the presented solution of the 2D bar code and the resultant payment assurance, the following special features must be taken into account during the processing:

PC-franked mailpieces can be dropped off via all drop-off modalities, also via mailboxes.

Compliance with the described security measures is further enhanced by specifying the approval prerequisites for producers of components of the franking system that are relevant for the interfaces, especially for the producers and/or operators of customer systems.

Governing Norms, Standards and Requirements

International Postage Meter Approval Requirements (IPMAR)

Preferably, the regulations in the most recent version of the document titled

International Postage Meter Approval Requirements (IPMAR), UPU S-30, is applicable as are all norms and standards to which this document makes reference. Compliance with all of the requirements listed there, to the greatest extent possible, is recommended for the customer system.

Digital Postage Marks: Applications, Security & Design

Fundamentally, the regulations of the current version of the document titled Digital Postage Marks: Applications, Security & Design (UPU: Technical Standards Manual) are applicable as are all norms and standards to which this document makes reference. Compliance with the “normative” content as well as far-reaching observation of the “informative” content of this document, to the greatest extent possible, are recommended for the customer system.

Preferably, via the superordinated norms and standards, the rules and regulations of each postal service provider are likewise applicable.

The data security and the reliability of the system as well as its user-friendliness are ensured by approving only those systems that fulfill all of the statutory regulations as well as all of the norms and standards of the postal service provider.

Additional Laws, Rules, Regulations, Guidelines, Norms and Standards

Fundamentally, all laws, rules, regulations, guidelines, norms and standards in their currently valid version that must be observed for the development and operation of a technical customer system in the actual execution are applicable.

Technical System Interoperability

Technical system interoperability relates to the functionality of the interfaces of the customer system, or to the compliance with the specifications set forth in the interface descriptions.

Accounting Interface

Communication Path, Protocols

The communication via the accounting interface preferably takes place via the public Internet on the basis of the TCP/IP and HTTP protocols. The data exchange can optionally be encrypted per HTTP via SSL (https). The target process of a necessary transmission is depicted here.

To the extent possible, the data exchange preferably takes place via HTML-coded and XML-coded files. The text and graphic contents of the HTML pages should be displayed in the customer system.

In the case of communication pages, it seems advisable to turn to a well-established HTML version and to dispense with the use of frames, embedded objects (Applets, ActiveX, etc.) and optionally animated GIFs.

Sign-On to Load an Account Amount (First Transmission from the Security Module to the Value Transfer Center)

Within the scope of the first transmission from the security module to the value transfer center, the certificate of the security module as well as an action indicator A are transmitted in non-encrypted and unsigned form.

Acknowledgement of the Sign-On (First Response from the Value Transfer Center to the Security Module)

The acknowledgement of the value transfer center contains the value transfer center's own certificate, an encrypted session key and the digital signature of the encrypted session key.

Second Transmission from the Security Module to the Value Transfer Center

Within the scope of this transmission, the security module transmits the newly encrypted session key, the encrypted random number and the encrypted data record with utilization data (level of a previously loaded account amount, remaining value of the current account amount, ascending register of all account amounts, last loading procedure identification number) (all asymmetrically encrypted with the public key of the value transfer center). At the same time, the security module transmits the digital signature of this encrypted data During the same period of time, the customer system can transmit additional, non-encrypted and unsigned utilization journals or utilization profiles to the value transfer center.

It is advantageous for the utilization data to be entered into a utilization journal and for the utilization journal and/or the entries recorded therein to be digitally signed.

Second Response from the Value Transfer Center to the Security Module

The value transfer center transmits the symmetrically encrypted random number and the symmetrically encrypted loading procedure identification number to the security module. Moreover, the value transfer center transmits to the security module the loading procedure identification number, log-in information for the security module as well as a new session key, which have been generated with the public key of the security module. All of the transmitted data is also digitally signed.

Third Transmission from the Security Module to the Value Transfer Center

Within the scope of the third transmission, the security module transmits the new session key, the new loading procedure identification number together with utilization data to confirm successful communication, all in encrypted and digitally signed form, to the value transfer center.

Third Response from the Value Transfer Center to the Security Module

In the third response, the value transfer center acknowledges the success of the transmission without the use of cryptographic methods.

De-Installation

The option of de-installation of the customer system by the customer must be possible.

The detailed technical description of the accounting interface is presented with the concept of the postal authority's own value transfer center.

Utilization Journal and Utilization Profile

In the customer system, within the scope of each generation of a postage indicium, a journal entry has to be generated that must contain all information about each postage indicium—provided with a digital signature of the security module. Moreover, each error status of the security module has to be recorded in the journal in such a way that the manual deletion of this entry is noticed during the verification procedure.

The utilization profile contains a prepared summary of the utilization data since the last communication with the value transfer center.

If a customer system is divided into a component located at the premises of the customer as well as a central component (e.g. in the Internet), then the utilization profile has to be maintained in the central component.

Postage Indicium Interface

Components and Execution

The customer system has to be capable of creating PC indicia that correspond precisely to the specifications of the Deutsche Post, or to the framework of the commonly used CEN and UPU standards.

PC indicia preferably consist of the following three elements:
A two-dimensional line code, bar code or matrix code, in which mailing-specific information is depicted in machine-readable form. (Purpose: automation in the processing and in the payment assurance system of the Deutsche Post.)
Plain text showing important parts of the bar code information in readable form. (Purpose: control option for the customer in the processing and in the payment assurance system of the Deutsche Post.)
A logo identifying the postal service provider, for example, the Deutsche Post such as, for example, the typical coach horn of the German Postal System.
   Specification of the Data Content

Advantageously, the bar code and the plain text of the PC postage indicium contain the following information:

Table: Content of the PC Postage Indicium

Only the content of the postage indicium is described here. The requirements of the postal service provider retain their validity for the content of the address data.

Specification of the Physical Appearance on Paper (Ayout)

The postage indicium is advantageously applied in the address field so as to be left-aligned above the address on the mailpiece.

The address field is specified in most recent valid version of the standards of the postal service provider. In this manner, the following postage indicia are made possible:
imprint on the envelope
imprint on adhesive labels or
use of window envelopes in such a way that the imprint on the letter is completely visible through the window.

The following preferably applies to the individual elements of the postage indicium:
Firstly, the bar code of the data matrix type is used; its individual pixels should have an edge length of at least 0.5 mm.
   In view of the reading-related technical prerequisites, it is preferable to use a 2D bar code in the form of the data matrix with a minimum pixel size of 0.5 mm. An optionally advantageous option is to reduce the pixel size to 0.3 mm.
   With a representation size of 0.5 mm per pixel, the edge length of the entire bar code is about 18 mm to 20 mm when all of the data is integrated as described. If bar codes with a pixel size of 0.3 mm can be read in the address reading machine, then the edge length can be reduced to 13 mm.
   A subsequent expansion of the specifications to the use of another bar code (e.g. Aztec) with the same data contents is possible.

A preferred embodiment of the layout and of the positioning of the individual elements of the postage indicium is shown by way of an example below in FIG. 5.

The “most critical” dimension is the height of the depicted window of a window envelope that measures 45 mm×90 mm in size. Here, a DataMatrix code with an edge length of about 13 mm is shown which, when the proposed data fields are used, is only possible with a pixel resolution of 0.3 mm. In terms of the available height, a code with an edge length of 24 mm does not leave sufficient space for information about the address.

Printing Quality and Readability

The flawless imprint of the postage indicium is the responsibility of the producer of the customer system within the scope of the approval procedure as well as the responsibility of the customer during the subsequent operations. For this purpose, the customer should be provided with suitable information in a user's manual and in a help system. This applies especially to the aspects of neatly adhering the labels and to preventing (parts of) the postage indicium from shifting outside of the visible area of window envelopes.

The machine-readability of postage indicia depends on the printing resolution used as well as on the contrast. If colors other than black are going to be used, then the reading rate can be expected to be lower. It can be assumed that the requisite reading rate can be met if a resolution of 300 dpi (dots per inch) is used in the printer along with a high printing contrast; this corresponds to about 120 pixels per centimeter.

Test Imprints

The customer system has to be capable of creating postage indicia whose appearance and size match valid postage indicia, but that are not intended for mailing but rather for test imprints and fine adjustments of the printer.

Preferably, the customer system is configured in such a way that the test imprints can be distinguished from actual postage indicia in a manner that the postal service provider can readily recognize. For this purpose, for example, the words “SAMPLE—do not mail” can be printed in the middle of the postage indicium. At least two-thirds of the bar code should be rendered unrecognizable by the words or in some other manner.

Aside from real (paid) postage indicia, except for specially marked test imprints, no blank imprints may be made.

Requirements of the Customer System

Basic System

Overview and Functionality

The basic system serves as a link between the other components of the PC franking, namely, the value transfer center, the security module, the printer and the customer. It consists of one or more computer systems, for example, PCs, that can optionally also be networked with each other.

The invention makes it possible to interrupt the further process of calculating a postage amount at various steps of the process that generates the postage indicia.

1. A method for providing mailpieces with postage indicia, whereby a customer system controls the printing of postage indicia on mailpieces, characterized in that, an entry is made in a file indicating which postage indicia generated by a printing command were not associated with the sending of a mailpiece, and in that the customer system transmits identification data to the server pertaining to the mailpieces that are not to be sent, in that the server forwards the identification data to at least one checking station, and in that the checking station recognizes a mailpiece that has been mailed even though the postage indicium used by the customer system was marked as not sent.

2. The method according to claim 1, characterized in that the information of the file is incorporated into a fee refund form.

3. The method according to one or both of claims 1 or 2, characterized in that the file and/or the fee refund form are transmitted to a refund station.

4. The method according to claim 3, characterized in that the transmission is made to a server.

5. The method according to one or more of the preceding claims, characterized in that the transmission takes place via an e-mail.

6. The method according to one or more of the preceding claims, characterized in that the transmission takes place at a website.
